(19) United States
(12) Patent Application Publication
(10) Pub. No.: US 2003/0095806 A1
(43) Pub. Date: May 22, 2003

(54) Oiler system for a reproduction apparatus fuser assembly

(76) Inventors: Fangsheng Wu, Rochester, NY (US); Timo Straub, Geislingen (DE); Muhammed Aslam, Rochester, NY (US)

Correspondence Address: Lawrence P. Kessler, Patent Department, NexPress Solutions LLC, 1447 St. Paul Street, Rochester, NY, 14653-7103, US

(21) Appl. No.: 09/991,342

(22) Filed: Nov. 17, 2001

(51) Int. Cl. G03G 15/20

(52) U.S. Cl. 399/45; 399/325

(57) ABSTRACT

A fuser assembly for an electrostatographic reproduction apparatus, the fuser assembly including a fuser member and a pressure member in operative association to apply heat and pressure to a marking particle image carried by a receiver member to fix such image to the receiver member as the receiver member passes through the fuser member and pressure member, and an oiler system for the fuser assembly. The oiler system includes an applicator for laying down a release oil on at least the fuser member, and a logic and control unit for selectively activating the applicator to lay down release oil in a predetermined amount based on known characteristics of the receiver member and the content of the marking particle image thereon.

### FIELD OF THE INVENTION

This invention relates in general to a fuser assembly for a reproduction apparatus, and more particularly to an oiler system for a reproduction apparatus fuser assembly.

### BACKGROUND OF THE INVENTION

In typical commercial reproduction apparatus (electrostatographic copier/duplicators, printers, or the like), a latent image charge pattern is formed on a uniformly charged charge-retentive or photoconductive member having dielectric characteristics (hereinafter referred to as the dielectric support member). Pigmented marking particles are attracted to the latent image charge pattern to develop such image on the dielectric support member. A receiver member, such as a sheet of paper, transparency or other medium, is then brought into contact with the dielectric support member, and an electric field applied to transfer the marking particle developed image to the receiver member from the dielectric support member. After transfer, the receiver member bearing the transferred image is transported away from the dielectric support member, and the image is fixed (fused) to the receiver member by heat and pressure to form a permanent reproduction thereon.

One type of fuser assembly for typical electrographic reproduction apparatus includes at least one heated roller, having an aluminum core and an elastomeric cover layer, and at least one pressure roller in nip relation with the heated roller. The fuser assembly rollers are rotated to transport a receiver member, bearing a marking particle image, through the nip between the rollers. The pigmented marking particles of the transferred image on the surface of the receiver member soften and become tacky in the heat. Under the pressure, the softened tacky marking particles attach to each other and are partially imbibed into the interstices of the fibers at the surface of the receiver member. Accordingly, upon cooling, the marking particle image is permanently fixed to the receiver member.

Certain reproduction apparatus recently introduced into the market have been designed to produce multi-color copies. In such reproduction apparatus, multiple color separation images are respectively developed with complementary colored marking particles, and then transferred in superposition to a receiver member. It has been found that fixing of multi-color marking particle images to a receiver member requires substantially different operating parameters than fixing standard black marking particle images to a receiver member. Moreover, the respective operating parameters may in fact be in contradistinction. That is, multi-color images require a high degree of glossiness for a full, rich depth of color reproduction; on the other hand, since glossiness for black marking particle images may significantly impair legibility, a matte finish is preferred.

It is known that the glossiness of a marking particle image is, at least in part, dependent upon the marking particle melting characteristics in the fixing process. In general, the fixing apparatus serves to soften or at least partially melt the marking particles, enabling the marking particles to permeate into the fibers of the receiver member so that the marking particles are fixed to the receiver member to give a glossy image reproduction. For example, the fixing apparatus may include a heated roller, which contacts the marking particles and the receiver member. With multi-color marking particle images, the multiple color marking particle images are respectively melted and fixed by the heated roller. If the color marking particle images are not sufficiently melted, light scattering cavities may occur in the copy, which degrades the color reproduction. Moreover, if the marking particles on the receiver member do not have a mirror-like surface, incident light is reflected by diffusion from the marking particle surface and is not admitted into the marking particle layers, making the colors on the receiver member appear dark and cloudy. Therefore low melting point marking particles are used. They yield few cavities and a hard flat surface so as to give glossy and vivid colors in the reproduction.

Low melting point marking particles are subject to increased image offset to the heating roller. This can produce undesirable defects in the reproduction or subsequent reproductions. Although image offset can be reduced by application of fusing oil to the heating roller, the use of such oil introduces further complications into the fusing system, such as handling of the oil and making sure that the layer of oil on the roller is uniform. Alternatively, a mechanical arrangement for reducing image offset, without the need for fusing oil, has been found. Such mechanical arrangement provides an elongated web which is heated to melt the marking particles and then cooled to cool the particles and facilitate ready separation of the receiver member with the marking particle image fixed thereto from the elongated web. The nature of operation of the elongated web arrangement also serves to increase the glossiness of the fixed marking particle image. As a result, such arrangement is particularly useful for multi-color image fusing, but is not particularly suitable for black image fusing.

With roller fuser assemblies, it is common practice to use release fluids, such as silicone oil for example, applied to the fuser roller surface to improve the release of image-carrying receiver members from the fuser roller. The most common types of release fluid applicators or oilers are a rotating wick roller, a donor/metering roller, an oil impregnated oiling web, an oil impregnated oiling pad or roller, or variations or combinations of the above. For example, U.S. Pat. No. 5,267,004 (issued on Nov. 30, 1993) describes a rotating wick roller oiler. Such oiler has a rigid porous core covered by a layer of Nomex material. An oil supply tube is inserted into the center of the rigid porous core. The tube supplies oil to the core. The porous core allows the oil to move slowly outwards to the Nomex layer and then apply to the fuser roller. U.S. Pat. No. 5,937,257 (issued on Aug. 10, 1999 to Xerox Corporation) utilizes two metering blades in a donor roller type oiler. One of the metering blades is retractable and is engaged only to reduce oil rate when printing on a transparent media. U.S. Pat. No. 5,974,293 (issued on Oct. 26, 1999 to Xerox Corporation) utilized a donor brush to apply oil to the fuser or pressure roller. A smooth metering roller and a metering blade, commonly used in a donor roller oiler, is used to transport certain amount of oil from oil sump to the donor brush. U.S. Pat. No. 6,222,606 (issued Apr. 24, 2001 to Xerox Corporation) utilizes a web arrangement to clean a fuser roller having a release oil supplied thereto by a donor roll system.

### SUMMARY OF THE INVENTION

According to this invention, a fuser assembly for an electrostatographic reproduction apparatus includes a fuser member and a pressure member in operative association to apply heat and pressure to a marking particle image carried by a receiver member to fix such image to the receiver member as the receiver member passes through the fuser member and pressure member, and an oiler system for the fuser assembly. The oiler system includes an applicator for laying down a release oil on at least the fuser member, and a logic and control unit for selectively activating the applicator to lay down release oil in a predetermined amount based on known characteristics of the receiver member and the content of the marking particle image thereon.

The invention, and its objects and advantages, will become more apparent in the detailed description of the preferred embodiment presented below.

### BRIEF DESCRIPTION OF THE DRAWINGS

In the detailed description of the preferred embodiments of the invention presented below, reference is made to the accompanying drawings, in which:

FIG. 1 is a schematic side elevational view of an electrostatographic reproduction apparatus fusing assembly including an oiler mechanism according to this invention;

FIG. 2 is a schematic side elevation view of an alternate embodiment of the fusing assembly, partly in cross-section with portions removed to facilitate viewing; and

FIGS. 3a and 3b are respective schematic side elevational views of an alternate embodiment of the fusing assembly showing a gravure pattern cleaning device.

### DETAILED DESCRIPTION OF THE INVENTION

Release of a receiver member, bearing a marking particle image, from a reproduction apparatus fuser assembly depends on the marking particles chemistry, marking particles coverage, receiver type, surface energy of the fusing member, release fluid quantity and type, fuser nip geometry, and the reproduction apparatus process speed. Many of the above parameters are considered and then fixed during the design of a roller fusing system. Typically, the fusing parameters including the oil rate are designed for the most critical operational case for the particular reproduction apparatus. However, the marking particle coverage and the receiver type (weight, coated/uncoated, grain direction) can vary from image to image, especially in modem digital printers recently introduced to the market. Therefore, it is desirable, for most efficient fusing of marking particle images to a variety of receiver members, that the release fluid be adjusted according to the image content and the receiver member type. For example, with lower marking particle coverage, or coated papers and plastic foils, less release fluid would be required for similar effective fusing of higher marking particle coverage.

For a given fusing assembly and a specific marking particle set, release fluid application rates can be determined and stored, for various image (marking particle) coverages and receiver types, as a look-up-table in the main reproduction apparatus logic and control unit or the fuser control unit. The receiver member material script (i.e., the physical properties of the material), and the image content are available from a processor for the image to be reproduced and/or the logic and control unit of the printer. While an image to be reproduced by the printer is being rasterized, an appropriate receiver is selected, and the information about the image and the receiver member is sent to the machine logic and control unit. Accordingly, the fuser operating parameters, based on the image and the receiver member type, are searched and loaded from the look-up-table. The oiling rate is matched to a desired value necessary for an adequate release of the particular receiver member from the fusing member for the particular receiver member and image content.

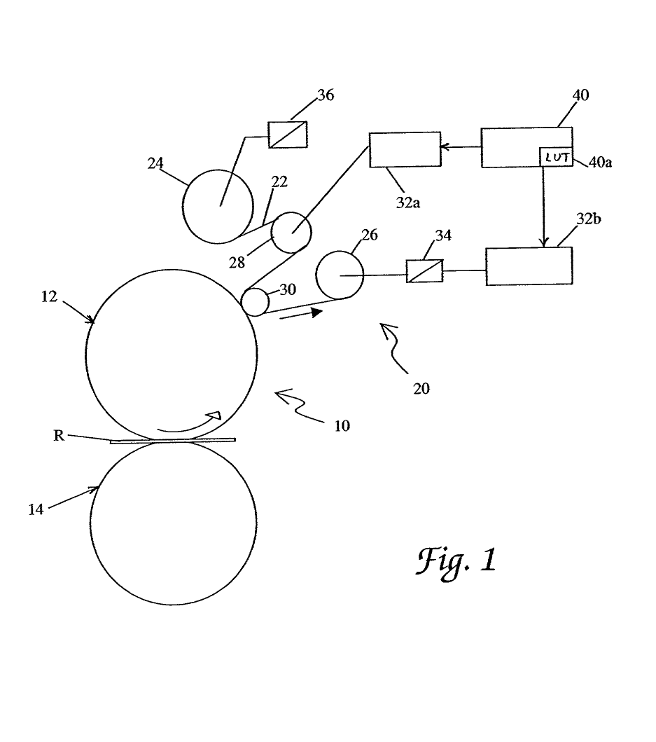

Referring to FIG. 1, various components of an electrographic reproduction apparatus fuser assembly including an oiler device, according to this invention, are shown. The fuser assembly, designated generally by the numeral 10, has a fusing member 12 in the form of a roller, although a belt, sleeve, or any other variation thereof would be applicable. The fusing member 12 is heated, and is located in nip relation with a pressure roller 14. The fusing nip between the rollers 12 and 14 is associated with the receiver member transport path of the reproduction apparatus. That is, as a receiver member bearing a marking particle image travels along the transport path, the marking particle image is fixed to the receiver member by application of heat and pressure in the fusing nip before the receiver member is delivered from the transport path to an output device or a duplex reproduction recirculation path.

The oiler device, according to this invention, is designated generally by the numeral 20. The oiler device 20 includes an elongated web 22 extending from a supply reel 24 to a take-up reel 26. The elongated web 22 is, for example, formed as a porous membrane capable of retaining release oil. Illustrative examples of such porous membrane would be micro-porous PTFE web materials, or non-woven polyester web materials. The elongated web 22 is impregnated with any well known release oil, for example silicone oils with functional groups such as amino or mercaptu groups. In this embodiment, that portion of the web 22 between the supply reel 24 and take-up reel 26 is directed about intermediate rollers 28 and 30. The intermediate roller 28 is a drive roller, driven by a motor 32a, for removing the web from the supply reel 24. The intermediate roller 30 is a back-up roller urging the web into intimate contact with the fusing member 12 to apply impregnated oil from the web to the fusing member surface. The take-up reel 26 is coupled to a drive motor 32b through a slip clutch 34 for winding the web on the take-up reel. The supply reel 24 has a slip clutch 36 associated therewith for maintaining tension in the web as it is fed from the supply reel and wound on the take-up reel. As shown the direction of movement of the web 22 is opposite to the direction of movement of the surface of the fusing member 12.

Motors 32a, 32b (may be a single motor with plural output drives) are operatively associated with a logic and control unit 40 to receive appropriate activation signals therefrom to turn on the motors for a predetermined period of time. The logic and control unit 40 includes, for example, a microprocessor receiving appropriate input signals. Based on such signals and a suitable program for the microprocessor, the unit 40 produces signals to control operation of the reproduction apparatus and carrying out of the reproduction process. The production of the program for a number of commercially available microprocessors is a conventional skill well understood in the art. The particular details of any such program would, of course, depend upon the architecture of the designated microprocessor.

As noted above, the logic and control unit 40 may be located in the main reproduction apparatus logic and control or in the separate logic and control for the fuser assembly 10. A look-up-table 40a is incorporated in the logic and control unit 40. The look-up-table interrelates the drive for the motors 32a, 32b with the receiver member type and the image content. Accordingly, the movement of the web 22 relative to the fuser member 12 effects a controlled lay down of release oil per receiver member. Therefore, excess oil on the receiver member is substantially avoided, particularly on coated and transparent media, and oil-related artifacts in the image on the receiver member is prevented. Moreover, less oil is carried out by the fused reproduction copies (e.g., during duplex printing), and thus there is potential for less contamination of other reproduction apparatus systems by the release oil.

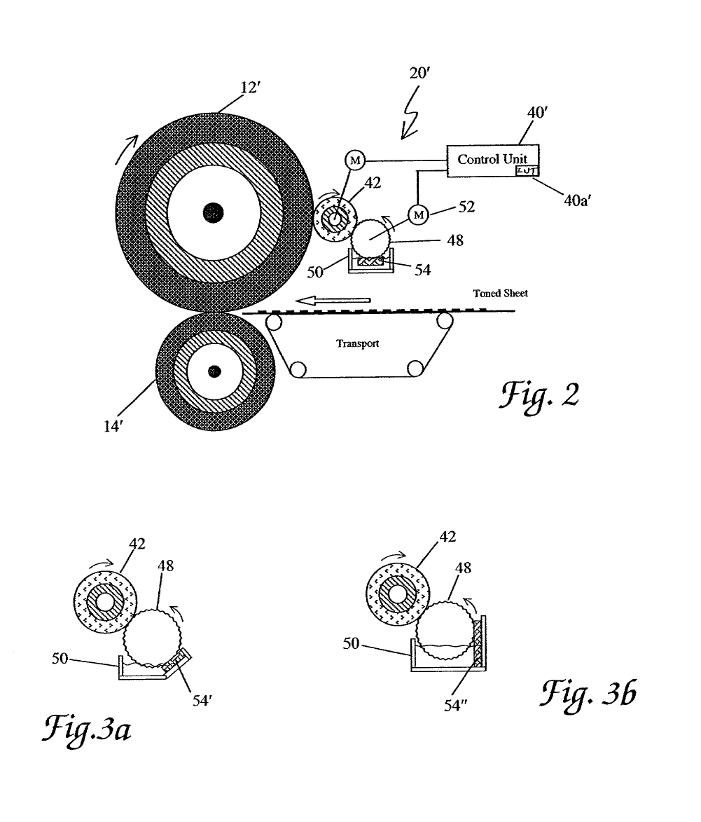

In the embodiment of this invention shown in FIG. 2, the oiler delivery rate and uniformity are addressed by an alternate oiler device, designated by the numeral 20′. The oiler device 20′ utilizes a donor roller 42 selectively driven by a motor 44 in the direction opposite the direction of movement of the fusing member 12′ of the fuser assembly 10′. An oil supply roller 48 is used to transport release oil from a sump 50 to the donor roller 42. The oil supply roller is driven by a motor 52. The motors 44 and 52 are operatively associated with and controlled by the logic and control unit 40′, substantially identical to unit 40 in FIG. 1. As with the unit 40, unit 40′ has a look-up-table 40a′ which interrelates the drive for the motors 44 and 52 with the receiver member type and the image content. Accordingly, the motors are selectively activated to provide a desired controlled lay down of release oil per receiver member, which is effected by the rotation of the oil supply roller 48 and donor roller 42 relative to the fuser member 12′.

The relative motion between the donor roller 42 and the fuser member 12′ improves the oil uniformity in the direction perpendicular to the length of the fuser member. Unlike the oil tube of the prior art, with finite number of openings used in conventional rotating wick roller, an oil supply roller provides oil uniformly in roller length direction. The surface speed of the donor roller 42 may be in the range of approximately 10-400 mm/sec. The oil rate is controlled by the rotational speed of the oil supply roller 48. To increase the oil deliverability, the surface of the oil supply roller 48 is textured or gravured. The surface of the oil supply roller 48 having parallel longitudinal grooves is an illustrative example of gravuring. The oil supply roller may rotate in the speed range of approximately 0.01-10 mm/sec to provide oil rate of 1-10 μl per A4 sheet. The width and the depth of the gravures could vary in the range of 0.1-5 mm according to the need of fuser assembly 10′.

The oil supply roller 48 is rotated in the direction of the donor roller 42 so that the newly supplied release oil will go through the nip between the donor roller and the oil supply roller to further uniformly spread out the release oil. The donor roller should form nips with the oil receiving fuser member 12′ and the oil supply roller 48, respectively having a width in the range of 1-5 mm. A wick pad 54, in the oil sump 50, is used to prevent an air cavity from forming on the oil supply roller 48. Alternatively, the oil supply roller 48 and the wick pad 54 can also be arranged in selectively different orientations (see wick pads 54′, 54″ found in FIGS. 3a and 3b respectively). Advantages of the described oiler device are a wide range of release oil delivery rate controllability is provided, and the oil rate can be changed easily by changing the oil supply roller speed. Moreover, this arrangement is relatively low in cost since both the donor roller and oil supply roller can be made of low cost materials and no metering blade is required.

The invention has been described in detail with particular reference to preferred embodiments thereof, but it will be understood that variations and modifications can be effected within the spirit and scope of the invention.

What is claimed is:

1. A fuser assembly for an electrostatographic reproduction apparatus, said fuser assembly including a fuser member and a pressure member in operative association to apply heat and pressure to a marking particle image carried by a receiver member to fix such image to said receiver member as said receiver member passes through said fuser member and pressure member, and an oiler system for said fuser assembly, said oiler system comprising:
an applicator for laying down a release oil on at least said fuser member; and
a logic and control unit for selectively activating said applicator to lay down release oil in a predetermined amount based on known characteristics of said receiver member and the content of the marking particle image thereon.

2. The fuser assembly oiler system according to claim 1 wherein said logic and control unit includes a look-up table plotting characteristics of different receiver members and characteristics of images with various content.

3. The fuser assembly oiler system according to claim 2 wherein said applicator includes a web impregnated with release oil.

4. The fuser assembly oiler system according to claim 3 wherein said applicator web is a porous membrane capable of holding silicone oils with functional groups such as amine or mercaptu groups.

5. The fuser assembly oiler system according to claim 3 wherein said applicator includes a motor for selectively driving said web in a direction opposite to the direction of travel of the surface of said fuser member, said motor being associated with said logic and control unit so that said motor is turned on by said logic and control unit for a preselected period of time.

6. The fuser assembly oiler system according to claim 4 wherein said applicator includes a drive roller, a supply reel, and a take-up reel, said web extending from said supply reel, wrapped at least partially about said drive roller, to said take-up reel.

7. The fuser assembly oiler system according to claim 1 wherein said applicator includes a mechanism for applying a force to said supply reel to keep tension of the portion of said web being fed therefrom, and a drive motor associated with said take-up reel to wind a portion of said web on said take-up reel.

8. The fuser assembly oiler system according to claim 1 wherein said applicator includes a mechanism between said take-up reel and said take-up reel drive to limit the tension in the web as said web is wound on said take-up reel.

9. The fuser assembly oiler system according to claim 2 wherein said applicator includes a donor roller in operative association with said fuser member and a release oil supply roller contacting said donor roller to supply release oil thereto.

10. The fuser assembly oiler system according to claim 9 wherein said applicator includes a first motor connected to said donor roller, and a second motor connected to said release oil supply roller

11. The fuser assembly oiler system according to claim 10 wherein said first motor and said second motor are operatively associated with said logic and control unit so that said logic and control unit selectively regulates the activation of said first and second motor respectively.

12. The fuser assembly oiler system according to claim 11 wherein said release oil supply roller includes a rough textured surface.

13. The fuser assembly oiler system according to claim 12 wherein said release oil supply roller rough textured surface is a gravure pattern.

14. In association with a fuser assembly for an electrostatographic reproduction apparatus, said fuser assembly including a fuser member and a pressure member in operative association to apply heat and pressure to a marking particle image carried by a receiver member to fix such image to said receiver member as said receiver member passes through said fuser member and pressure member, and an applicator for applying release oil to said fuser assembly, a method controlling the application of release oil comprising the step of:
selectively activating said applicator to lay down release oil in a predetermined amount based on known characteristics of said receiver member and the content of the marking particle image thereon.

15. The method according to claim 1 wherein a look-up table plotting characteristics of different receiver members and characteristics of images with various content is provided.
